(19) United States
(12) Patent Application Publication
(10) Pub. No.: US 2019/0180339 A1
(43) Pub. Date: Jun. 13, 2019

(54) SERVER AND METHOD FOR MANAGING A USER PAIRING

(71) Applicant: Mastercard International Incorporated, Purchase, NY (US)

(72) Inventors: Kirubakaran Ellappan, Chennai (IN); Balu Ramamoorthy, Pune (IN); Pradeep Yadavalli, Pune (IN); Yuvraj Chalake, Pune (MH); Vijay Shantling Lamture, Pune (IN); Rajesh Pralhadrao Mahalle, Pune (IN); Rukuma Viegas, Pune (IN)

(73) Assignee: Mastercard International Incorporated, Purchase, NY (US)

(21) Appl. No.: 16/178,680

(22) Filed: Nov. 2, 2018

(30) Foreign Application Priority Data
Dec. 11, 2017 (SG) 10201710296Q

(51) Int. Cl. G06Q 30/06; G06Q 30/08; G06Q 20/14

(52) U.S. Cl. CPC G06Q 30/0611; G06Q 20/14; G06Q 30/08

(57) ABSTRACT

A server and method for managing a user pairing is provided. The method comprises receiving, from a target user device, target user information from a target user, the target user information including a product in which the target user is interested, a product amount of the product and a target user amount which the target user is willing to offer for the product; obtaining, from a database, user information to identify one or more users who have indicated interest in the product and are willing to offer a total amount which is equal to or more than a difference between the product amount and the target user amount; and sending, to the target user device, a pairing message informing the target user of a determination of a pairing of the target user and the identified one or more users.

### CROSS REFERENCE TO RELATED APPLICATIONS

This application claims priority to Singaporean Application Serial No. 10201710296Q, filed Dec. 11, 2017, which is incorporated herein by reference in its entirety

### TECHNICAL FIELD

The present invention relates broadly, but not exclusively, to servers and methods for managing a user pairing.

### BACKGROUND

With the proliferation of mobile communication devices, such as mobile telephones, financial account holders that have such devices have begun to use them to effect financial transactions.

Recently, there is an increasing number of users effecting financial transactions online e.g., using the Internet or via a mobile device application program. It is known that the customers are limited to enjoy offers that they are entitled to. For example, if a customer can only afford to buy one hundred dollars' worth of a product, he will not be able to enjoy an offer that is available for customers who buy one hundred and fifty dollars' worth of the product.

In other words, conventionally, it is impossible to enjoy other on-going promotions that the financial institutions or merchants are holding for a product that the customer is unable to afford. This often makes the shopping experience frustrating and unsatisfactory, especially when the customer is aware of such on-going promotions. For example, a customer typically browses online, selects the products (e.g., goods and/or services) and makes payment online.

In the recent time, financial institutions and merchants have enhanced the way in which they publicize their promotions and interest rates for instalments. When using such websites, for example, the customer is able to see descriptions of on-going promotions for a specific value of a product, which can then be searched by customers who access the website.

While such websites have provided an improved level of convenience to financial institutions and customers relative to other traditional methods, customers may not be able to make full use of such on-going promotions because of their limited spending powers.

A need therefore exists to provide methods for managing a transaction for a customer that addresses one or more of the above problems, so that the customer may enjoy the benefits of the on-going promotions.

Furthermore, other desirable features and characteristics will become apparent from the subsequent detailed description and the appended claims, taken in conjunction with the accompanying drawings and this background of the disclosure.

### SUMMARY

According to a first aspect of the present invention, there is provided a server for managing a dynamic user/user pairing, the server comprising: at least one processor; and at least one memory including computer program code; the at least one memory and the computer program code configured to, with the at least one processor, cause the server at least to: receive, from a target user device, target user information from a target user, the target user information including a product in which the target user is interested, a product amount of the product and a target user amount which the target user is willing to offer for the product; obtain, from a database, user information to identify one or more users who have indicated interest in the product and are willing to offer a total amount which is equal to or more than a difference between the product amount and the target user amount; and send, to the target user device, a pairing message informing the target user of a determination of a pairing of the target user and the identified one or more users.

In an embodiment, the target user information comprises a location information of the target user and the at least one memory and the computer program code is further configured with the at least one processor to: identify the one or more users in response of the location information of the target user.

In an embodiment, the at least one memory and the computer program code is further configured with the at least one processor to: receive a transaction request, from the target user device, to purchase the product in response to the pairing message, the transaction request including target user account details and details relating to the identified one or more users.

In an embodiment, the at least one memory and the computer program code is further configured with the at least one processor to: forward, to an issuer server associating with an issuer indicated in the target user account details, the transaction request.

In an embodiment, the at least one memory and the computer program code is further configured with the at least one processor to: receive, from the issuer server, a transaction approval message informing that the amount that the target user is willing to offer for the product has been transferred; send, to the target user device, the transaction approval message; and send, to a corresponding device of the identified one or more users, the transaction approval message.

In an embodiment, the at least one memory and the computer program code is further configured with the at least one processor to: receive a further transaction request, from the corresponding device of the identified one or more users, to purchase the product in response to the transaction approval message, the further transaction request including account details relating to the corresponding identified one or more users and an amount that the corresponding identified one or more users is willing to pay for the product.

In an embodiment, the at least one memory and the computer program code is further configured with the at least one processor to: forward, to a corresponding issuer server associating with a corresponding issuer indicated in the account details relating to the corresponding identified one or more users, the further transaction request.

In an embodiment, the at least one memory and the computer program code is further configured with the at least one processor to: receive, from the corresponding issuer server, a further transaction approval message informing that the amount that the corresponding identified one or more users is willing to offer for the product has been transferred; and send, to the corresponding device of the identified one or more users, the further transaction approval message.

In an embodiment, the at least one memory and the computer program code is further configured with the at least one processor to: forward, to a merchant device, a notification message informing the merchant who is providing the product that the product amount has been transferred.

In an embodiment, the at least one memory and the computer program code is further configured with the at least one processor to: allocate a corresponding reward to each of the target user and the corresponding identified one or more users.

In an embodiment, the at least one memory and the computer program code is further configured with the at least one processor to: send, to the target user device, a message informing the target user of a termination of the pairing of the target user and the identified one or more users after a predetermined period of time.

In an embodiment, the product amount comprises a total number of the product or a monetary amount of the product.

According to a second aspect of the present invention, there is provided a computer-implemented method for managing an account for a user who does not own a bank account, the account suitable for non-credit cash transactions, the method comprising: receiving, from a target user device, target user information from a target user, the target user information including a product in which the target user is interested, a product amount of the product and a target user amount which the target user is willing to offer for the product; obtaining, from a database, user information to identify one or more users who have indicated interest in the product and are willing to offer a total amount which is equal to or more than a difference between the product amount and the target user amount; and sending, to the target user device, a pairing message informing the target user of a determination of a pairing of the target user and the identified one or more users.

In an embodiment, the method further comprises identifying the one or more users in response of the location information of the target user.

In an embodiment, the method further comprises receiving a transaction request, from the target user device, to purchase the product in response to the pairing message, the transaction request including target user account details and details relating to the identified one or more users.

In an embodiment, the method further comprises forwarding, to an issuer server associating with an issuer indicated in the target user account details, the transaction request.

In an embodiment, the method further comprises receiving, from the issuer server, a transaction approval message informing that the amount that the target user is willing to offer for the product has been transferred; sending, to the target user device, the transaction approval message; and sending, to a corresponding device of the identified one or more users, the transaction approval message.

In an embodiment, the method further comprises receiving a further transaction request, from the corresponding device of the identified one or more users, to purchase the product in response to the transaction approval message, the further transaction request including account details relating to the corresponding identified one or more users and an amount that the corresponding identified one or more users is willing to pay for the product.

In an embodiment, the method further comprises forwarding, to a corresponding issuer server associating with a corresponding issuer indicated in the account details relating to the corresponding identified one or more users, the further transaction request.

In an embodiment, the method further comprises: receiving, from the corresponding issuer server, a further transaction approval message informing that the amount that the corresponding identified one or more users is willing to offer for the product has been transferred; and sending, to the corresponding device of the identified one or more users, the further transaction approval message.

In an embodiment, the method further comprises forwarding, to a merchant device, a notification message informing the merchant who is providing the product that the product amount has been transferred.

In an embodiment, the method further comprises allocating a corresponding reward to each of the target user and the corresponding identified one or more users.

In an embodiment, the method further comprises sending, to the target user device, a message informing the target user of a termination of the pairing of the target user and the identified one or more users after a predetermined period of time.

According to a third aspect of the present invention, there is provided a computer-implemented method for managing an account for a user who does not own a bank account, the account suitable for non-credit cash transactions, the method comprising: receiving a request to search for a deal; receiving a first input indicating a product in the deal in which a target user is interested, the input including a product amount of the product and a target user amount which the target user is willing to offer for the product; associating the request and the input to identify one or more users who have indicated interest in the product and are willing to offer a total amount which is equal to or more than a difference between the product amount and the target user amount; displaying user information of the identified one or more users who have indicated interest in the product; and receiving a second input indicating a confirmation of a pairing between the target user and the identified one or more users, the input including a transaction request to purchase the product.

In an embodiment, displaying user information to identify one or more users may be based on location information of the target user.

In an embodiment, displaying user information to identify one or more users may be based on the total amount which is equal to or more than a difference between the product amount and the target user amount.

In an embodiment, the method further comprises displaying a transaction approval message that the amount that the target user is willing to offer for the product has been transferred.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram of a server 100 within which a user can be dynamically paired.

FIGS. 2a to 2d shows a flow chart illustrating a computer-implemented method for a dynamic user pairing according to an example embodiment.

FIG. 2e shows a table illustrating types of information stored in a database during a method for managing a user pairing, according to an example embodiment.

FIG. 3 shows a schematic diagram illustrating the flow of information between various entities during a method for managing a user pairing, according to an example embodiment.

FIGS. 4a and 4b show schematic diagrams illustrating the flow of information during a method for managing a user pairing, according to an example embodiment.

FIG. 5 shows a schematic diagram illustrating the flow of information from an application program perspective during a method for managing a user pairing, according to an example embodiment.

FIG. 6 shows a schematic diagram of a computer system suitable for use in executing the method depicted in FIGS. 2a to 2d.

FIG. 7 shows an exemplary computing device to realize a server for the facilitating server 102 shown in FIG. 1.

### DETAILED DESCRIPTION

### Overview

Various embodiments of the present disclosure provide a server and a system that manages a user pairing, more specifically pairing a user with one or more users who are interested in a deal of a product.

A merchant may register himself on an application program for participating and advertising for a deal for his product. A first user, who is also registered on the application program, may be interested in the deal but does not wish to pay the full amount of the deal himself. Instead, he wants to share it with other users. For example, a first user (or a target user), ABC is interested in a deal of $10 for a set of fifteen tubes of toothpaste. However, ABC wishes to have three tubes of toothpaste.

A search is conducted for other registered users. For example, information relating to other users may be obtained from a database identifying users who have indicated interest in an item (e.g. toothpaste) indicated in the offer or the offer (e.g. $10 for a set of fifteen tubes of toothpaste). A second registered user (e.g. DEF) may also wish to contribute only a partial amount of the same deal. The second user may also wish to offer an amount that is equal to or more than a difference between the product amount and the amount that the first user wishes to pay. Continuing from the above example, a search indicates that DEF, who is also interested in the deal, wish to pay for twelve tubes of toothpaste.

After the search is conducted successfully, that is at least one second user is found, partial details of the second user (such as name and address) are then transmitted to the first user. In this case, interaction is limited between the first user and the second user. For example, the first user may only read product reviews of the second user but will be unable to reply to his reviews. Additionally or alternatively, the first user may be unable to add the second user to his contacts at this point. The first user may then decide whether to accept the pairing and share the deal with the second user. It is also possible for the first user to be informed that the second user has been paired with him, without having a choice to select or approve a pairing. If the first user accepts the pairing, the second user will be notified and partial details of the first user will be sent to the second user whereby interaction is also limited.

It can be appreciated that there can also be more than two users for a deal. From the above example, ABC is interested in a deal of $10 for a set of fifteen tubes of toothpaste and only needs three tubes of toothpaste. DEF may be interested in the same deal and is willing to pay for seven tubes of toothpaste. A third user GHJ may also be interested in the same deal and is willing to pay for five tubes of toothpaste. In this case, ABC, DEF and GHJ are paired together. That is, user ABC may be informed that users DEF and GHJ will be paired with him.

After the pairing is finalized, full details (including details that were not sent earlier) of the first user and the second user (such as name, address and phone number) are exchanged such that a full interaction may be realized between the users. For example, the first user may reply to product reviews of the second user and the first user may also store the details of the second user to his contacts. The first user and the second user also input the amount they are willing to offer for the deal. The product is delivered to each of the first and second user and a predetermined time period for the pairing may be specified so that the pairing can be terminated automatically after the first and second users have received their products.

### Terms Description (In Addition to Dictionary Meaning of Terms)

A target user or one or more users refers to a consumer who wishes to purchase products from a merchant. The consumer may be interested in a product or products that are on offer or are part of a deal and may be registered on an application program. Being a registered user on the application program allows the user to view currently available products on offer from various merchants. Further, the target user and each of the one or more users may have a corresponding device (a target user device or a user device) such as a portable computing device which he is able to install and view the application program. Examples of such a device may be a mobile phone, a laptop or a tablet. In many instances, the target user is one who has to be paired with at least one other user.

A product amount is the cost (or a monetary amount) of the product that is on offer by a merchant. The product amount may be lower than the normal retail price of the product. In an alternative embodiment, the product amount may also be a total number of the product to be purchased. For example, a tube of toothpaste may cost $3 each at the normal retail price while a deal may offer fifteen similar tubes of toothpaste for a total of $10.

A target user amount is an amount that the target user is willing to offer for the product. For example, the target user is willing to pay $3 for an offer of $10 for fifteen tubes of toothpaste. Thus, the target user amount is $3. The target user amount may also be an amount that corresponds to the number of available points of his credit card. In this case, the target user may have 15 points available for redemption on his credit card, which is equal to a monetary amount $3.

User information refers to information that is related to the target user or each of the one or more users. Such information may include name, address, age, gender, a photograph, place of birth, contact number, date of birth, at least a type of item of interest, a type of deal of interest and a corresponding amount that he is willing to pay for the item/deal (or product) of interest. User information may be provided by the user during registration and may be stored in a database administered by a facilitator module.

A pairing message refers to a message that is sent to the target user during the pairing between the target user and the one or more users (or second users). The pairing message may include at least partial user information relating to the one or more users and may also include a confirmation that the target user is paired with the one or more users.

A deal refers to an offer of products from the merchant. The deal may include an amount, often discounted, for a set of products. Where the amount included in the deal is a monetary amount, it may be cheaper than the normal retail price for a set of similar products. For example, a tube of toothpaste may cost $3 each at the normal retail price while the deal may offer fifteen similar tubes of toothpaste for a total of $10. Additionally, or alternatively, the amount included in the deal may refer to an amount of products or quantity of products. For example, the target user ABC is interested in a deal of $10 for a set of fifteen tubes of toothpaste but wishes to have only three tubes of toothpaste. In an alternative embodiment, the deal may include a reward for the products on offer. For example, the deal may offer cashback of $2 for purchasing a set of fifteen tubes of toothpaste.

### Exemplary Embodiments

Embodiments of the present invention will be described, by way of example only, with reference to the drawings. Like reference numerals and characters in the drawings refer to like elements or equivalents.

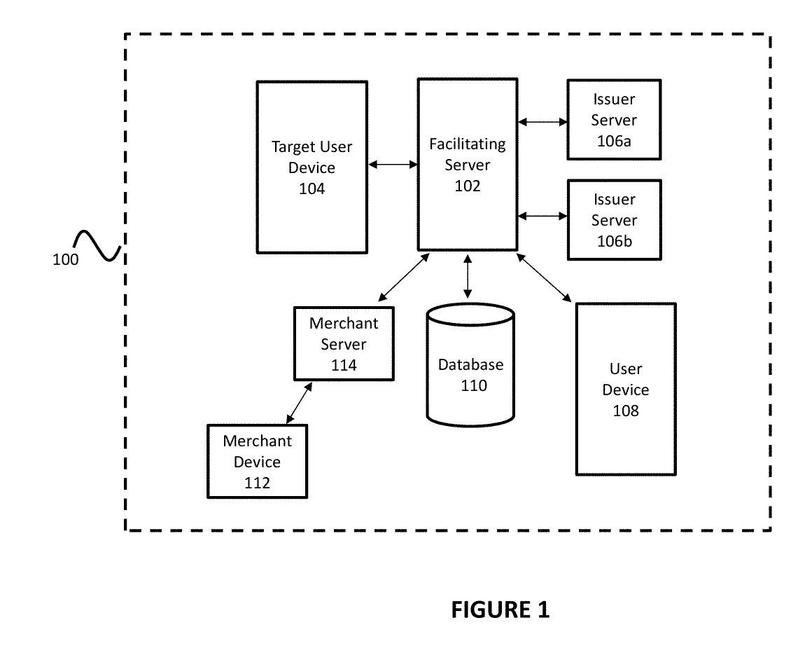

FIG. 1 illustrates a block diagram of a system 100 within which a user can be dynamically paired. The system 100 comprises a facilitating server 102 in communication with a target user device 104, one or more issuer server 106a, 106b, a user device 108, a database 110 and a merchant device 112.

The target user device 104 and the user device 108 are typically associated with a user (or customer) who is a party to a transaction that occurs between the target user device 104, the user device 108 and the merchant device 112. The user device 108 may be associated with the second user or the one or more users. The transaction may refer to a financial transaction, including a transaction request, between the target user and the merchant for the purchase of a product in a deal which the target user is interested in. The transaction may thus involve the exchange of good, services or money between the target user and the merchant.

The target user device 104 and the user device 108 may be a fixed (wired) computing device or a wireless (portable) computing device. In specific implementations, the target user device 104 and the user device 108 may be a handheld or portable or mobile device carried or used by the customer, or may refer to other types of electronic devices such as a personal computer, a land-line telephone or an interactive voice response (IVR) system and the like. The mobile device may be a device, such as a mobile phone, a laptop computer, a personal digital computer (PDA), a mobile computer, a portable music player (such as an iPod™ and the like).

The merchant device 112 typically is associated with the merchant who is also a party to the transaction that occurs between the target user device 104 and the user device 108 and the merchant device 112 through the transaction. The merchant device 112 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

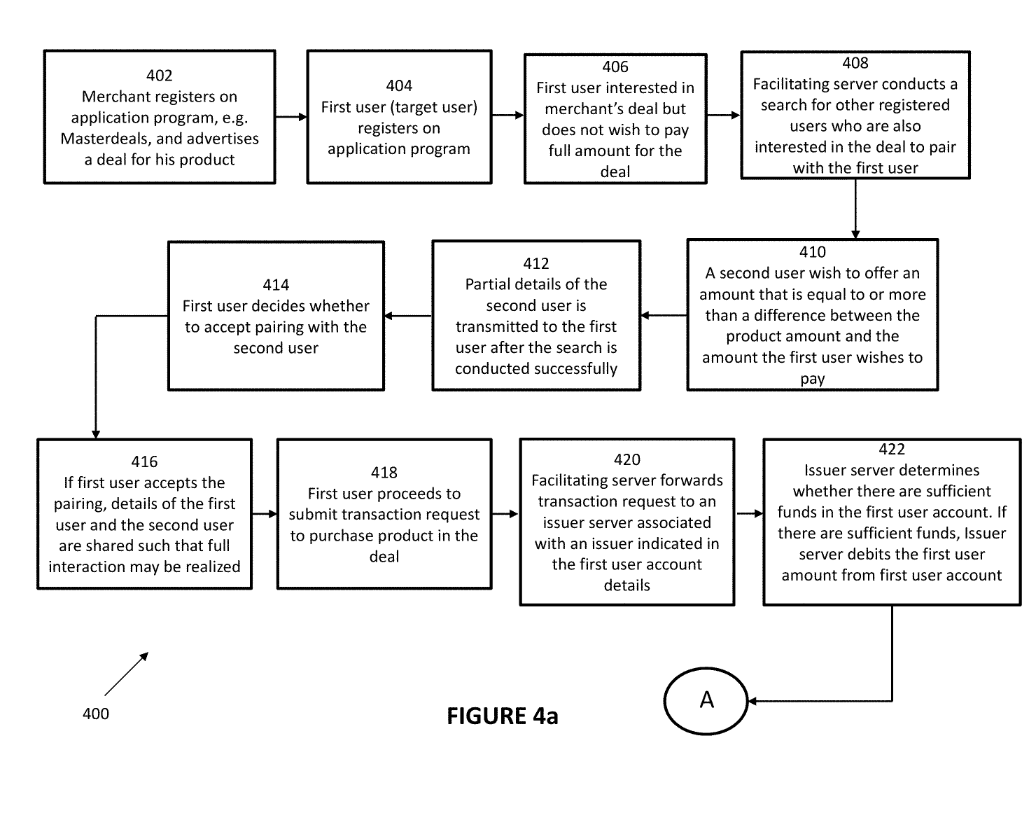

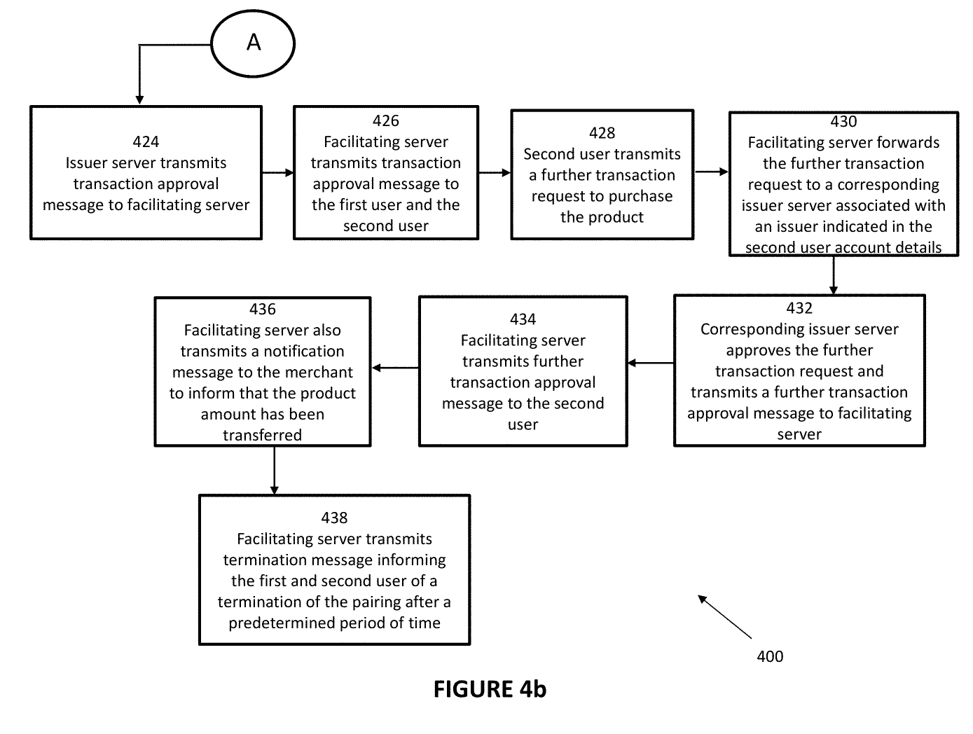

The facilitating server 102 typically is associated with a payment facilitator. For example, the facilitating server 102 may be the Banknet® network operated by MasterCard®. The payment facilitator (e.g. MasterCard®) may be an entity (e.g. a company or organization) who operates to process transactions, clear and settle funds for payments between two entities (e.g. two banks). The facilitating server 102 may include one or more computing devices that are used for processing transactions. For various embodiments below, the payment facilitator (e.g. MasterCard®) may be an entity (e.g. a company or organization) which issues (e.g. establishes, manages, administers) a transaction credential or an account (e.g. a financial bank account) of the merchant. An exemplary facilitating server 102 is shown in FIG. 4.

Each of the issuer server 106a, 106b generally is associated with a corresponding issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of target user devices 104 and the user devices 108.

The facilitating server 102 may be configured to communicate with, or may include, a database (or a transaction database) 110. The database 110 stores data corresponding to a plurality of users. Examples of the data include User ID, User Name, User Account, User Address and Postal Code and or other relevant information that is provided when the user signs up for an application program managed by the facilitating server 102. For example, data relating to the user, such as the user's biological data are included in the database 109. The database 110 may also store data corresponding to a transaction. Examples of the data include Transaction ID, Merchant ID, Merchant Name, MCC/Industry Code, Industry Description, Merchant Country, Merchant Address, Merchant Postal Code, Aggregate Merchant ID and or other relevant information that is provided when the merchant signs up for an application program and advertises a deal in the application. For example, data (“Merchant name” or “Merchant ID”) relating to the merchant, the deal details and validity for which the goods/services relating to the transaction are included in the database 110.

The target user device 104 and the user device 108 are capable of wireless communication using a suitable protocol with the merchant device 112. For example, embodiments may be implemented using the target user device 104 and the user device 108 that are capable of communicating with Wi-Fi/Bluetooth-enabled merchant devices 112. It will be appreciated by a person skilled in the art that depending on the wireless communication protocol used, appropriate handshaking procedures may need to be carried out to establish communication between the target user device 104 and the user device 108 and the merchant device 112. For example, in the case of Bluetooth communication, discovery and pairing of the target user device 104 and the merchant device 112 may be carried out to establish communication.

During a transaction, a transaction request is generated at the target user device 104. The transaction request may contain target user information from the target user, the target user information including a product in which the target user is interested, a product amount of the product and a target user amount which the target user is willing to offer for the product. For example, the target user signs up for an application program administered by the facilitating server 102. The application program may be a standalone application that is installed in the target user device 104 and the user device 108. In an alternative embodiment, the application program may be a web portal executing on the target user device 104 where the target user may initiate the transaction request. The target user then searches for deals in the application program and chooses a deal he wishes to participate in. He enters the amount he is willing to contribute onto his device 104 and the information is transmitted to the facilitating server 102. In this case, the transaction is carried out remotely, such as through a website. For example, the target user ABC uses his mobile phone and finds a deal of $10 for fifteen tubes of toothpaste. However, he requires only three tubes of toothpaste. In this case, the target user may be the first consumer who indicates an interest in the deal. In other words, the transaction request may include a date and time stamp of the transaction request. Similarly, the application program may be a web portal, executing on the user device 108, where the user may sign up in.

In another implementation, the transaction request may also be initiated at a retail shop of the merchant. In this case, the application program may be installed and executed on the POS terminal of the merchant. In particular, the facilitating server 102 and a merchant server 114 that is associated with the merchant device 112 may be administered by the same entity which may provide the application program. Therefore, the application program may be provided by the facilitating server 102 or the merchant server 114. In specific implementations, the target user device 104 may be fitted with a wireless communications interface such as a Near Field Communication (NFC) interface to enable the target user device 104 to electronically communicate with the facilitating server 102 to perform the transaction. NFC is a set of standards to establish radio communication between devices by bringing them into close proximity such as only a few centimetres. NFC standards cover communication protocols and data exchange formats, and are based on radio-frequency identification (RFID) technology. That is, the target user device 104 may have image capturing capabilities and capture an image of a quick response (QR) code displayed on the merchant device 112. The captured QR code includes an account identifier identifying the merchant and the merchant's account.

In an implementation, the merchant registers for an account on an application program executing on the merchant device 112. The application program is one that is managed by the facilitating server 102. At the time of registering for the account, the merchant provides information (e.g., name, a photograph, place of birth, contact number and date of birth, type of product, type of deal etc.) to the facilitating server 102. The facilitating server 102 may verify the information which may be in a form of checking if the received information is complete or check if the received information corresponds to one in a black-list. The facilitating server 102 may generate an account in response to a verification of the received information.

Thereafter, the facilitating server 102 obtains, from a database, user information to identify one or more users who have indicated interest in the product and are willing to offer a total amount which is equal to or more than a difference between the product amount and the target user amount. In an embodiment, the facilitating server 102 identifies one or more users who have shown an interest in an item identified in a deal or a deal. This information may be provided at the time of registering an account on the application once the facilitating server 102 identifies the one or more users who have shown an interest in the product, it may then determine if a total amount that the identified one or more users are willing to pay is equal to or more than a difference between the product amount and the target user amount. The facilitating server 102 may determine the one or more users from the date and time stamp of their interest in the deal and may also transmit a notification to the one or more identified users to indicate the target user is the first consumer who is interested in the deal.

With reference to the earlier example, ABC may be willing to offer $3 for a deal of $10 for a set of fifteen tubes of toothpaste. In this case, the difference between the product amount and the target user ABC amount is $7. The facilitating server 102 then searches for other users who are willing to pay $7 or more. It finds a second user, DEF, who is also interested in the deal, who wishes to pay $7. The facilitating server 102 then sends ABC partial details of DEF including the amount that DEF is willing to pay for the deal, e.g. $7. In this case, ABC may only view DEF's partial details, such as DEF's name, but will be unable to interact with DEF.

In another embodiment, there can also be more than two users for a deal. From the above example, ABC is interested in a deal of $10 for a set of fifteen tubes of toothpaste and only wishes to pay $3. A second user DEF may be interested in the same deal and is willing to pay $5. A third user GHJ may also be interested in the same deal and is willing to pay $2. In this case, the facilitating server 102 may pair ABC, DEF and GHJ together in order to participate in the deal of $10 for a set of fifteen tubes of toothpaste.

In yet another embodiment, the one or more users may also be determined by the difference between the number of products on offer and the number of products that the target user wishes to have. For example, target user ABC is willing to pay for three tubes of toothpaste for a deal of $10 for a set of fifteen tubes of toothpaste. DEF may need five tubes of toothpaste. GHJ may need seven tubes of toothpaste. In this case, the facilitating server may also pair ABC, DEF and GHJ even though the total amount that ABC, DEF and GHJ are willing to pay exceeds the deal of $10.

After the pairing message is sent to the target user, the target user may decide whether to accept the identified one or more users as a partner to the deal. If the target user accepts, he will proceed to purchase the product in response to receiving the pairing message by submitting a transaction request, via the target user device 104. Further, full details of the first user and the second user (such as name, address and phone number) are exchanged such that full interaction may be realized between the users after the pairing is finalized. The transaction request may include target user account details and details relating to the identified one or more users. The facilitating server 102 may forward the transaction request to an issuer server 106a associating with an issuer indicated in the target user account details.

In an embodiment, the facilitating server 102 pairs the target user and the identified one or more users without receiving acceptance of the pairing from the target user. In this case, the pairing message notifies the target user that he is paired with the one or more users and prompts the target user to enter the amount that will be debited from his account. The facilitating server 102 may also generate the transaction request to be sent to the issuer server 106a.

When the issuer server 106a receives the transaction request, it may determine whether there are sufficient funds in the target user's account based on the target user account details and target user amount. If there are sufficient funds, the issuer server 106a debits the target user amount from the target user account.

The issuer server 106a then transmits a transaction approval message to the facilitating server 102 informing the payment facilitator that the amount that the target user is willing to offer for the product has been transferred. The facilitating server 102 then sends the transaction approval message, to the target user device and to a corresponding user device 108 of the identified one or more users. The one or more users then decide whether to accept the transaction with the target user via the user device 108. If the one or more users accepts the transaction, a further transaction request is transmitted to the facilitating server 102 to purchase the product in response to the transaction approval message via the corresponding device of the identified one or more users 108. The further transaction request may include account details relating to the corresponding identified one or more users and an amount that the corresponding identified one or more users is willing to pay for the product.

The facilitating server 102 subsequently forwards the further transaction request to a corresponding issuer server 106b (which may be the same as the issuer server 106a for the target user) associated with a corresponding issuer indicated in the account details relating to the corresponding identified one or more users. If the transaction is approved by the issuer server 106b, a further transaction approval message will be transmitted to the facilitating server 102 informing that the amount that the corresponding identified one or more users is willing to offer for the product has been transferred. The facilitating server 102 then sends the further transaction approval message to the corresponding device 108 of the identified one or more users.

At the same time, the facilitating server 102 forwards a notification message to a merchant device 112 informing the merchant who is providing the product that the product amount has been transferred. The facilitating server 102 may also allocate a corresponding reward (e.g., loyalty points) to each of the target user and the corresponding identified one or more users after the transaction is approved by the corresponding issuer servers 106a, 106b. In certain cases, the deal may be valid for a limited amount of time. In this case, the facilitating server 102 may send a message to the target user device 104 informing the target user of a termination of the pairing of the target user and the identified one or more users after a predetermined period of time.

As mentioned above, the role of the facilitating server 102 is to facilitate communication between the target user device 104, the issuer servers 106a 106b, the merchant device 112 and/or the one or more user device 108. In specific implementations, the facilitating server 102 may be further configured to perform additional operations. For example, the facilitating server 102 may be configured to update the database 110 whenever a merchant registers for an account or the merchant has a new deal which he wishes to advertise. Additionally, the facilitating server 102 may also be configured to calculate a reliability score for each user based on the historical transactions (including repayment of loans) relating to the user. The historical transactions may be a ledger or a record of transactions that have been carried out using the account. In an implementation, the facilitating server 102 may be a payment network server administered by the payment facilitator. In another implementation, the facilitating server 102 may be part of the issuer server 106a or 106b and administered by the issuer. In yet another embodiment, the facilitating server 102 may be the merchant server 114 that is associated with the merchant.

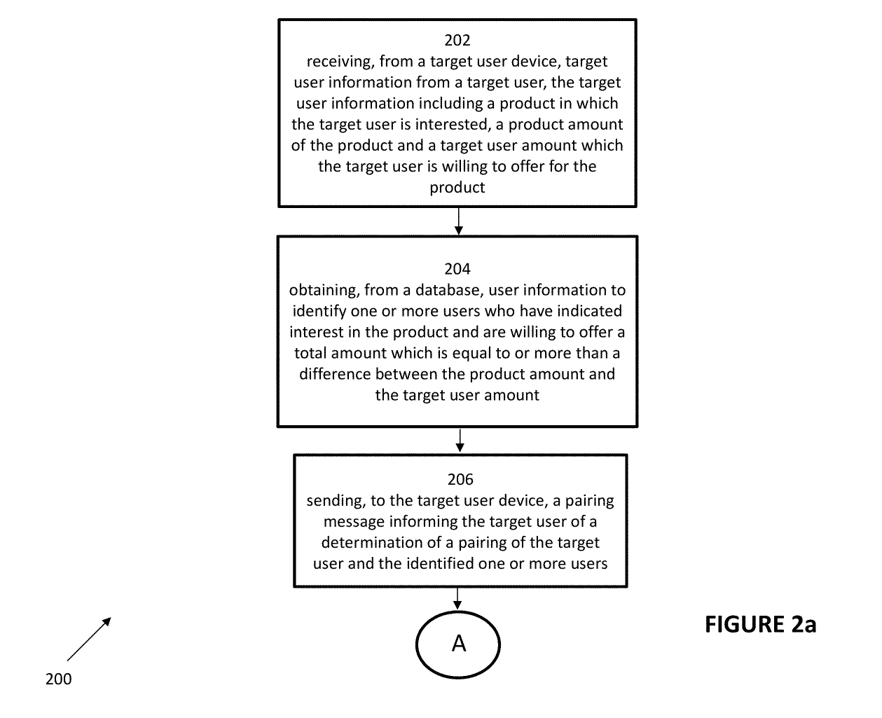

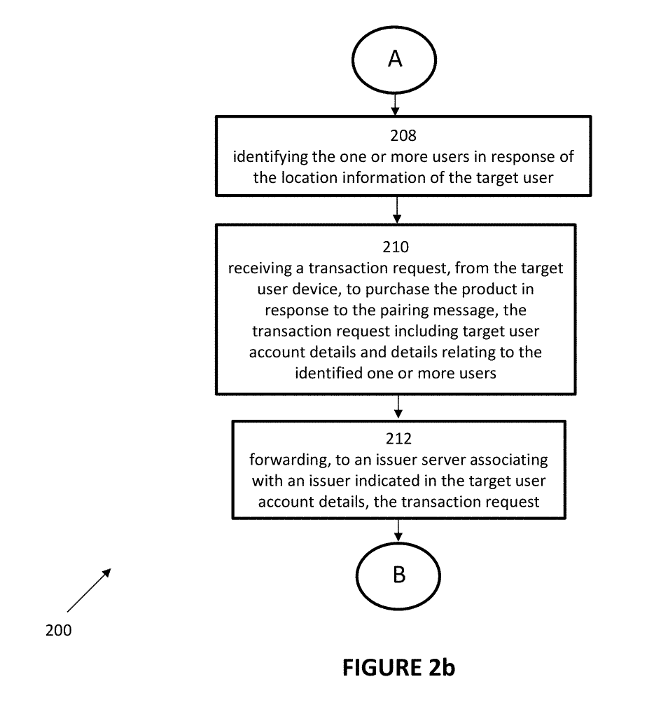

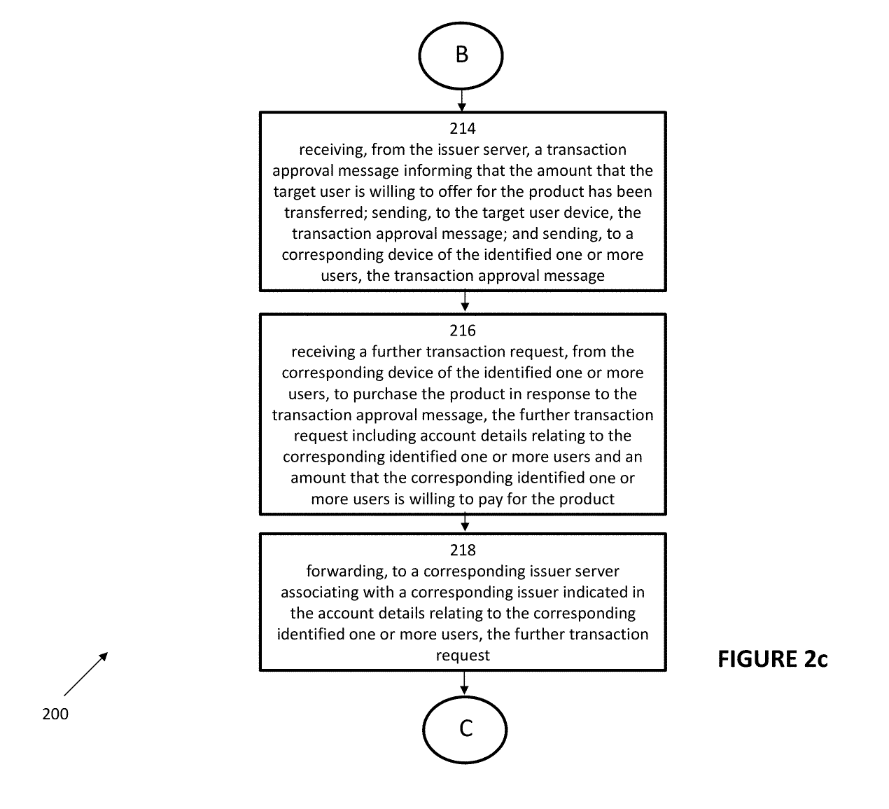

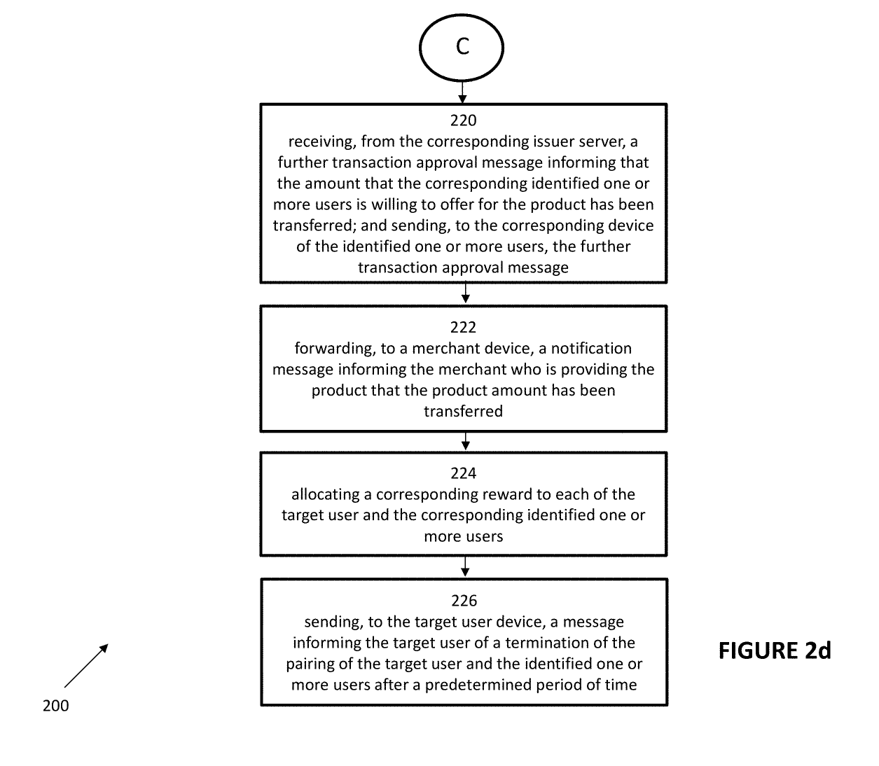

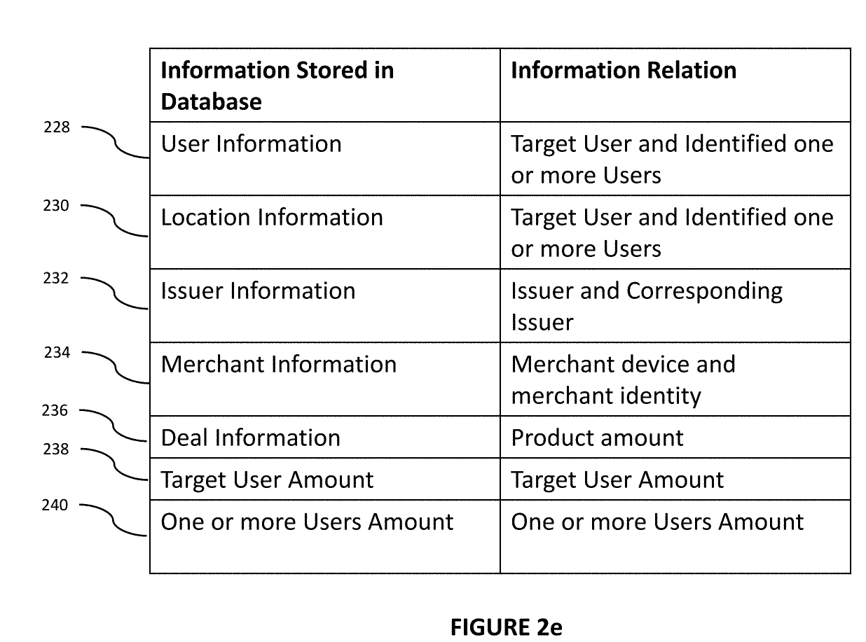

Such a server may be used to implement the method 200 shown in FIGS. 2a to 2d. FIGS. 2a to 2d show a flowchart illustrating a method 200 for a dynamic user pairing while FIG. 2e shows a table illustrating types of information stored in a database during a method for managing a user pairing, according to an example embodiment.

The method 200 broadly includes at step 202 receiving, from a target user device, target user information from a target user, the target user information including a product in which the target user is interested, a product amount of the product and a target user amount which the target user is willing to offer for the product. In an embodiment, the product amount may be stored as deal information 236 in the database (see FIG. 2e) when the merchant registers on the application program and advertises his products in a deal. It may be appreciated that the provision of the information 236, 238 are those sent from the target user device 104 to the facilitating server 102 which saves to the database 110. As shown in FIG. 2e, the target user amount 238 may also be stored in the database. At step 204, the method includes obtaining, from a database, user information to identify one or more users who have indicated interest in the product and are willing to offer a total amount which is equal to or more than a difference between the product amount and the target user amount. As shown in FIG. 2e, user information 228 relating to the target user and the identified one or more users may be stored in the database. At this step, user information 228 may be obtained to identify the one or more users. At step 206, the method includes sending, to the target user device, a pairing message informing the target user of a determination of a pairing of the target user and the identified one or more users.

Continuing from FIG. 2a, at step 208 in FIG. 2b, the method further includes identifying the one or more users in response of the location information of the target user. In an embodiment, the stored location information of the target user 230 shown in the table of FIG. 2e may be obtained from the database at this step.

At step 210, the method further includes receiving a transaction request, from the target user device, to purchase the product in response to the pairing message, the transaction request including target user account details and details relating to the identified one or more users. In an embodiment, the target user account details and details relating to the identified one or more users may be part of the user information 228 of the table in FIG. 2e. The target user account details and details relating to the identified one or more users may thus be obtained from the database at this step.

At step 212, the method further includes forwarding, to an issuer server associating with an issuer indicated in the target user account details, the transaction request. In an embodiment, the issuer indicated in the target user account details may be part of the stored user information 228 of FIG. 2e and may be obtained at this step. In an alternative embodiment, an issuer identity and issuer details may also be obtained from issuer information 232 stored in the database at this step.

Continuing from FIG. 2b, at step 214 in FIG. 2c, the method further includes receiving, from the issuer server, a transaction approval message informing that the amount that the target user is willing to offer for the product has been transferred; sending, to the target user device, the transaction approval message; and sending, to a corresponding device of the identified one or more users, the transaction approval message. In an embodiment, the target user device and the corresponding device of the identified one or more users may be identified through the stored user information 228.

At step 216, the method further includes receiving a further transaction request, from the corresponding device of the identified one or more users, to purchase the product in response to the transaction approval message, the further transaction request including account details relating to the corresponding identified one or more users and an amount that the corresponding identified one or more users is willing to pay for the product. In an embodiment, the account details relating to the corresponding identified one or more users may be part of the user information 228 of the table in FIG. 2e and may thus be obtained from the database at this step. The amount that the corresponding identified one or more users is willing to pay for the product may also be stored as one or more users amount 240 in the database.

At step 218, the method further includes forwarding, to a corresponding issuer server associating with a corresponding issuer indicated in the account details relating to the corresponding identified one or more users, the further transaction request. In an embodiment, the corresponding issuer indicated in the account details relating to the corresponding identified one or more users may be part of the stored user information 228 of FIG. 2e and may be obtained at this step. In an alternative embodiment, a corresponding issuer identity and corresponding issuer details may also be obtained from issuer information 232 stored in the database at this step.

Continuing from FIG. 2c, at step 220 in FIG. 2d, the method further includes receiving, from the corresponding issuer server, a further transaction approval message informing that the amount that the corresponding identified one or more users is willing to offer for the product has been transferred; and sending, to the corresponding device of the identified one or more users, the further transaction approval message.

At step 222, the method further includes forwarding, to a merchant device, a notification message informing the merchant who is providing the product that the product amount has been transferred. In an embodiment, the notification message may be forwarded to the merchant device via the merchant server. In an embodiment, merchant information 234 may be stored in the database during the registration of the merchant in the application program. The merchant information 234 may include an identity of the merchant device and the merchant device thus may be identified from the stored merchant information 234 at this step.

At step 224, the method further includes allocating a corresponding reward to each of the target user and the corresponding identified one or more users. In an embodiment, the reward to be allocated to the target user and the corresponding identified one or more users may be based on the stored target user amount 238 and one or more users amount 240.

At step 226, the method further includes sending, to the target user device, a message informing the target user of a termination of the pairing of the target user and the identified one or more users after a predetermined period of time.

In an embodiment, steps 222 and 224 may be performed by the merchant server 114 that is associated with the merchant device 112. In another embodiment, the payment network server may perform steps 202, 204, 206, 208, 210, 212, 214, 216, 218, 220 and 226.

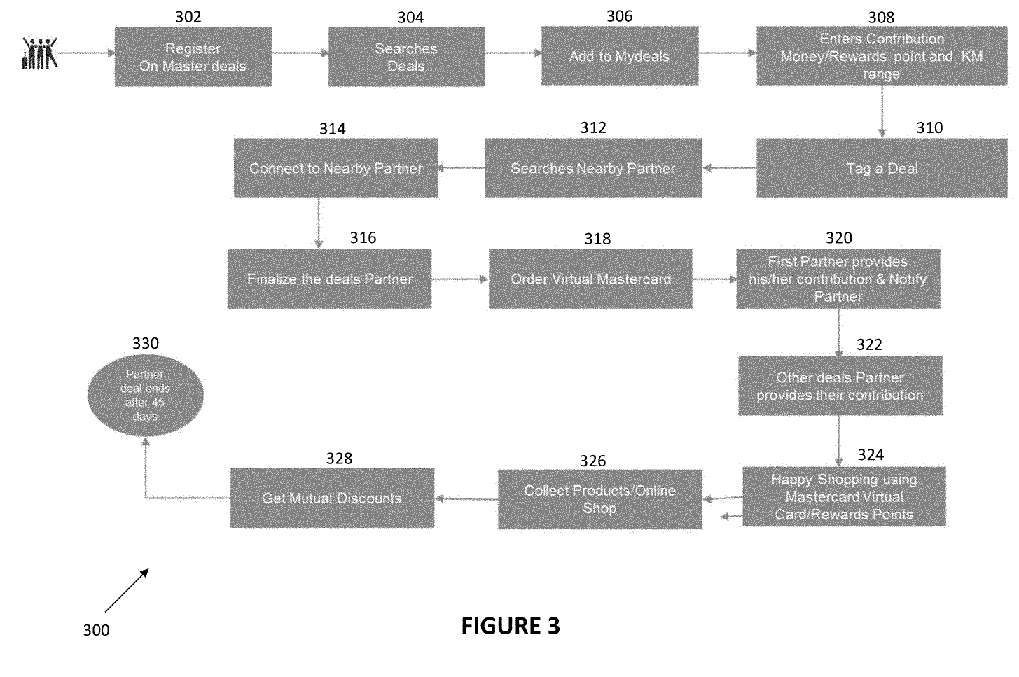

FIG. 3 shows a schematic diagram 300 illustrating the flow of information between various entities during a method for managing a user pairing, according to an example embodiment. At step 302, a target user registers on application program, for example “Master deals”. At step 304, the target user searches for deals that are available in the program. The target user may search for deals using search filters present in the program. Such search filters may include a monetary amount, reward points, number of products, type of products, location of merchant, merchant credibility, and/or a combination of any of the aforementioned. At step 306, the target user sees a deal that he is interested (e.g. from a result of his search in step 304) and adds it to “Mydeals”, which may be a personal portal of the target user in the program. At step 308, the target user enters a contribution amount or a rewards point that he is willing to pay for the deal. In an implementation, the program may have access to different reward points for various cards that are registered in the program. In this case, the target user may view his available rewards points across each of his different cards in the program and use a combination of the rewards points from more than one card. Therefore, the rewards point entered by the target user may be combined from different cards or from the same card. In an example, the program may provide a list of users registered to the program, who are willing to offer an offer equal to or more than that of the target user. For example, if a deal requires 1,000 points and the target user is willing to offer 160 points, then a list of users willing to offer 900 points or more will be shown. The target user also enters a range (in kilometres) for pairing with another user. The target user contribution amount in this context may also refer to the target user amount as mentioned previously. That is, both refer to the amount that the target user is willing to offer for the product. At step 310, the target user tags the deal.

At step 312, the program searches for a nearby partner who resides within the range specified by the target user previously. At step 314, the program connects the nearby partner to the target user. At step 316, the target user finalizes and accepts the deals partner after receiving the partner's details. At step 318, an order for a virtual card (such as a Virtual Mastercard) is generated after the pairing is complete. At step 320, the target user provides the amount he wishes to contribute to the deal and notifies his partner. At step 322, the partner provides his contribution to the deal. In an alternative embodiment, the program may search and determine the partner based on the reward points entered by the target user and the amount of reward points of the partner. For example, the target user enters 30 reward points for the deal that requires 50 reward points. The program then searches for a partner or partners who have 20 or more reward points and displays the deal to that partner. In other words, the program filters and displays the deal only to partners who have minimum or required number of points If a partner has only 5 reward points, the program may not display the deal to him. At step 324, the virtual card or rewards points is used to pay for the deal. At step 326, the products of the deal are collected or ordered through an online portal. At step 328, each of the target user and his partner proceeds to obtain mutual discounts from the deal. At step 330, the pairing of the target user and his partner expires after a predetermined time period (for example 45 days).

FIGS. 4a and 4b show schematic diagrams illustrating the flow of information 400 during a method for managing a user pairing, according to an example embodiment. At step 402, a merchant registers on application program, e.g. Masterdeals, and advertises a deal for his product. At step 404, a first user (or target user) registers on the application program. At step 406, the first user is interested in the merchant's deal but does not wish to pay full amount for the deal. In an embodiment, the deal may be tagged by the first user on his watch list such that he may wish to participate in the deal at a later date. In another embodiment, the deal may be tagged to a real time list which the first user may choose to participate immediately. At step 408, a facilitating server conducts a search for other registered users who are also interested in the deal to pair with the first user. At step 410, a second user who is also interested in the deal may wish to offer an amount that is equal to or more than a difference between the product amount and the amount the first user wishes to pay. At step 412, partial details of the second user are transmitted to the first user after the search is conducted successfully. At step 414, the first user decides whether to accept pairing with the second user after receiving the partial details of the second user. At step 416, if the first user accepts the pairing, details of the first user and the second user are shared such that full interaction may be realized. At step 418, the first user proceeds to submit a transaction request to purchase the product in the deal. At step 420, the facilitating server forwards the transaction request to an issuer server associated with an issuer indicated in the first user account details. At step 422, the issuer server determines whether there are sufficient funds in the first user account. If there are sufficient funds, the issuer server debits the first user amount from the first user account.

Continuing from FIG. 4a, at step 424 in FIG. 4b, the issuer server transmits the transaction approval message to the facilitating server after the first user amount is debited from the first user account. At step 426, the facilitating server transmits transaction approval message to the first user and the second user. At step 428, the second user transmits a further transaction request to purchase the product. At step 430, the facilitating server forwards the further transaction request to a corresponding issuer server associated with an issuer indicated in the second user account details. At step 432, the corresponding issuer server approves the further transaction request and transmits a further transaction approval message to facilitating server. At step 434, the facilitating server transmits the further transaction approval message to the second user. At step 436, the facilitating server also transmits a notification message to the merchant to inform that the product amount has been transferred. At step 438, the facilitating server transmits a termination message informing the first and second user of a termination of the pairing after a predetermined period of time.

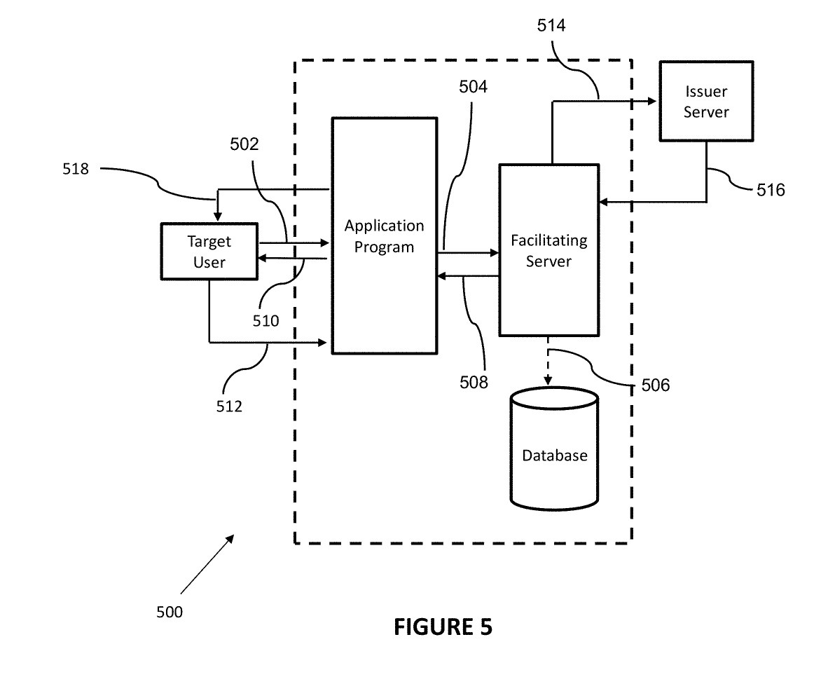

FIG. 5 shows a schematic diagram illustrating the flow of information 500 from an application program perspective during a method for managing a user pairing, according to an example embodiment. At step 502, the application program receives a request from a target user to search for a deal. At the same time, the application program also receives a first input indicating a product in the deal in which a target user is interested, the input including a product amount of the product and a target user amount which the target user is willing to offer for the product. The product amount may include a total number of the product or a monetary amount of the product. At step 504, the application program associates the request and the input to identify one or more users who have indicated interest in the product and are willing to offer a total amount which is equal to or more than a difference between the product amount and the target user amount and transmits the request and input to the facilitating server. At step 506, the facilitating server conducts a search in a database for other registered users who are also interested in the deal to pair with the target user. In an embodiment, the database and the application program may be administered by the facilitating server such that the search and the transmission of the selection are carried out internally without involving external entities. At step 508, the facilitating transmits user information to the application program after the search is completed. At step 510, the application program displays user information to identify one or more users who have indicated interest in the product and are willing to offer a total amount which is equal to or more than a difference between the product amount and the target user amount. The display of the user information may be based on location information of the target user or may be based on the total amount equal to or more than a difference between the product amount and the target user amount. At step 512, the application program receives a second input indicating a confirmation of a pairing between the target user and the identified one or more users. The input may include a transaction request to purchase the product. At step 514, the transaction request is transmitted, via the facilitating server, to an issuer server associated with an issuer of an account of the target user. At step 516, the issuer server approves the transaction after determining that the target user has sufficient funds. At step 518, the application program displays a transaction approval message that the amount that the target user is willing to offer for the product has been transferred.

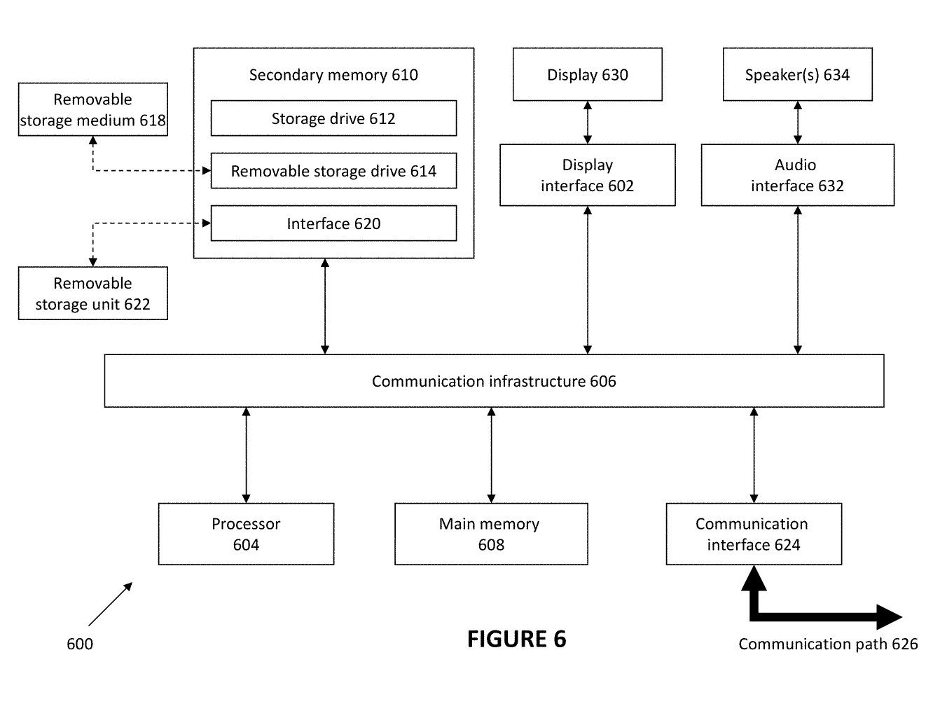

FIG. 6 depicts an exemplary computer/computing device 600, hereinafter interchangeably referred to as a computer system 600, where one or more such computing devices 600 may be used to facilitate execution of the above-described method. In addition, one or more components of the computer system 600 may be used to realize the facilitating server 102. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 618 in a well-known manner. The removable storage medium 618 may include magnetic tape, optical disk, non-volatile memory storage medium, or the like, which is read by and written to by removable storage drive 614. As will be appreciated by persons skilled in the relevant art(s), the removable storage medium 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port (such as a serial, parallel, printer, GPIB, IEEE 1394, RJ25, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage medium 618, removable storage unit 622, a hard disk installed in storage drive 612, or a carrier wave carrying software over communication path 626 (wireless link or cable) to communication interface 624. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the storage drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

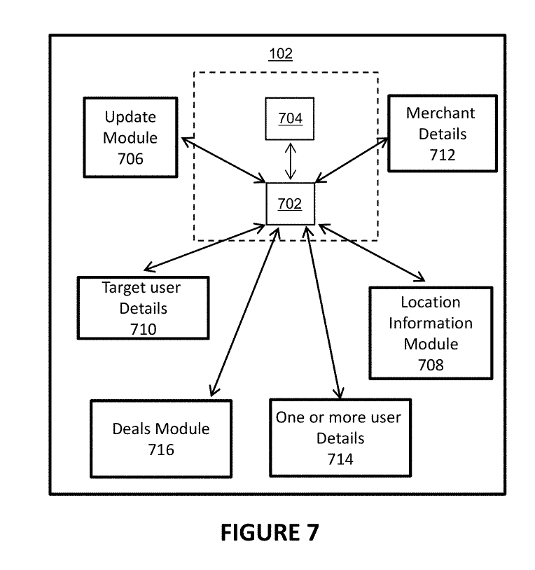

In an implementation, the facilitating server 102 may be generally described as a physical device comprising at least one processor 702 and at least one memory 704 including computer program code. The at least one memory 704 and the computer program code are configured to, with the at least one processor 702, cause the physical device to perform the operations described in FIGS. 2a to 2d. An example of the facilitating server 102 is shown in FIG. 7. The facilitating server 102 shown in FIG. 7 may also include an update module 706, a location information module 708, a target user details module 710, a merchant details module 712, a one or more user details module 714 and a deals module 716. The memory 704 stores computer program code that the processor 702 compiles to have each of the update module 706, the location information module 708, the target user details module 710, the merchant details module 712, the one or more user details module 714 and the deals module 716 perform their respective functions. With reference to FIG. 1, the update module 706 is configured to update the database 110 on the status of the transaction, the deal advertised by the merchant and details of the target user, the one or more users and the merchant. The location information module 708 is configured to receive location information of the target user and the one or more users. The target user details module 710 is configured to receive details of the target user while the merchant details module 712 and the one or more user details module 714 are configured to receive details of the merchant and details of the one or more user respectively. The deals module 716 is configured to receive details of the deal advertised by the merchant.

For example, the method of FIGS. 2a to 2d may be implemented as software and stored in a non-transitory fashion in the secondary memory 610 or the removable storage units 618, 622 of the computer device 600.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “analysing”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses server for performing the operations of the methods. Such server may be specially constructed for the required purposes, or may comprise a computer or other device selectively activated or reconfigured by a computer program stored in the computer. The algorithms and displays presented herein are not inherently related to any particular computer or other server. Various machines may be used with programs in accordance with the teachings herein. Alternatively, the construction of more specialized server to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in a server that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

What is claimed is:

1. A server for managing a dynamic user/user pairing, the server comprising:
at least one processor; and
at least one memory including computer program code;
the at least one memory and the computer program code configured to, with the at least one processor, cause the server at least to:
receive, from a target user device, target user information from a target user, the target user information including a product in which the target user is interested, a product amount of the product and a target user amount which the target user is willing to offer for the product;
obtain, from a database, user information to identify one or more users who have indicated interest in the product and are willing to offer a total amount which is equal to or more than a difference between the product amount and the target user amount; and
send, to the target user device, a pairing message informing the target user of a determination of a pairing of the target user and the identified one or more users.

2. The server according to claim 1, wherein the target user information comprises a location information of the target user and the at least one memory and the computer program code is further configured with the at least one processor to:
identify the one or more users in response of the location information of the target user.

3. The server according to claim 1, wherein the at least one memory and the computer program code is further configured with the at least one processor to:
receive a transaction request, from the target user device, to purchase the product in response to the pairing message, the transaction request including target user account details and details relating to the identified one or more users.

4. The server according to claim 3, wherein the at least one memory and the computer program code is further configured with the at least one processor to:
forward, to an issuer server associating with an issuer indicated in the target user account details, the transaction request.

5. The server according to claim 4, wherein the at least one memory and the computer program code is further configured with the at least one processor to:
receive, from the issuer server, a transaction approval message informing that the amount that the target user is willing to offer for the product has been transferred;
send, to the target user device, the transaction approval message; and
send, to a corresponding device of the identified one or more users, the transaction approval message.

6. The server according to claim 4, wherein the at least one memory and the computer program code is further configured with the at least one processor to:
receive a further transaction request, from the corresponding device of the identified one or more users, to purchase the product in response to the transaction approval message, the further transaction request including account details relating to the corresponding identified one or more users and an amount that the corresponding identified one or more users is willing to pay for the product.

7. The server according to claim 6, wherein the at least one memory and the computer program code is further configured with the at least one processor to:
forward, to a corresponding issuer server associating with a corresponding issuer indicated in the account details relating to the corresponding identified one or more users, the further transaction request.

8. The server according to claim 7, wherein the at least one memory and the computer program code is further configured with the at least one processor to:
receive, from the corresponding issuer server, a further transaction approval message informing that the amount that the corresponding identified one or more users is willing to offer for the product has been transferred; and
send, to the corresponding device of the identified one or more users, the further transaction approval message.

9. The server according to claim 8, wherein the at least one memory and the computer program code is further configured with the at least one processor to:
forward, to a merchant device, a notification message informing the merchant who is providing the product that the product amount has been transferred.

10. The server according to claim 9, wherein the at least one memory and the computer program code is further configured with the at least one processor to:
allocate a corresponding reward to each of the target user and the corresponding identified one or more users.

11. The server according to claim 1, wherein the at least one memory and the computer program code is further configured with the at least one processor to:
send, to the target user device, a message informing the target user of a termination of the pairing of the target user and the identified one or more users after a predetermined period of time.

12. The server according to claim 1, wherein the product amount comprises a total number of the product or a monetary amount of the product.

13. A computer-implemented method for managing an account for a user who does not own a bank account, the account suitable for non-credit cash transactions, the method comprising:
receiving, from a target user device, target user information from a target user, the target user information including a product in which the target user is interested, a product amount of the product and a target user amount which the target user is willing to offer for the product;
obtaining, from a database, user information to identify one or more users who have indicated interest in the product and are willing to offer a total amount which is equal to or more than a difference between the product amount and the target user amount; and
sending, to the target user device, a pairing message informing the target user of a determination of a pairing of the target user and the identified one or more users.

14. The method according to claim 13, further comprising:
identifying the one or more users in response of the location information of the target user

15. The method according to claim 13, further comprising:
receiving a transaction request, from the target user device, to purchase the product in response to the pairing message, the transaction request including target user account details and details relating to the identified one or more users.

16. The method according to claim 15, further comprising:
forwarding, to an issuer server associating with an issuer indicated in the target user account details, the transaction request.

17. The method according to claim 16, further comprising:
receiving, from the issuer server, a transaction approval message informing that the amount that the target user is willing to offer for the product has been transferred;
sending, to the target user device, the transaction approval message; and
sending, to a corresponding device of the identified one or more users, the transaction approval message.

18. The method according to claim 16, further comprising:
receiving a further transaction request, from the corresponding device of the identified one or more users, to purchase the product in response to the transaction approval message, the further transaction request including account details relating to the corresponding identified one or more users and an amount that the corresponding identified one or more users is willing to pay for the product.

19. The method according to claim 18, further comprising:
forwarding, to a corresponding issuer server associating with a corresponding issuer indicated in the account details relating to the corresponding identified one or more users, the further transaction request.

20. The method according to claim 19, further comprising:
receiving, from the corresponding issuer server, a further transaction approval message informing that the amount that the corresponding identified one or more users is willing to offer for the product has been transferred; and
sending, to the corresponding device of the identified one or more users, the further transaction approval message.
